(19) United States
(12) Patent Application Publication
(10) Pub. No.: US 2025/0229821 A1
(43) Pub. Date: Jul. 17, 2025

(54) Stroller Seat Lifting Apparatus and Stroller Comprising Same

(71) Applicant: Zhejiang Jinhua Snowbaby Baby Items Manufacturing Co., Ltd., Lanxi (CN)

(72) Inventors: Pin Qi Wang, Lanxi (CN); Sheng Jun Meng, Lanxi (CN); Xiu Bing Yu, Lanxi (CN)

(21) Appl. No.: 19/006,536

(22) Filed: Dec. 31, 2024

(30) Foreign Application Priority Data
Jan. 15, 2024 (CN) 2024100558806
Jan. 15, 2024 (CN) 2024200937935

(51) Int. Cl. B62B 9/10; A47D 1/00

(52) U.S. Cl. CPC B62B 9/102; A47D 1/004; B62B 2206/06

(57) ABSTRACT

A seat lifting apparatus includes a lifting platform attached to a seat. The lifting platform includes an unlocking element, a resilient element, and a positioning part. The positioning part comprises first and second contact surfaces and can move between first and second positions. The resilient element contacts the first contact surface and applies a force towards the second position. The unlocking element contacts the second contact surface and applies a force towards the first position. The base is disposed on a frame and includes a chamber. The lifting platform moves up and down within the chamber. The chamber includes limiting parts in the vertical direction. When the positioning part is in the second position, it matches with the limiting part to lock the seat height, and when the positioning part is in the first position, it separates from the limiting part to adjust the seat height.

### CROSS-REFERENCE TO RELATED APPLICATIONS

This application claims priority to Chinese Application Nos. 2024100558806 and 2024200937935, filed on Jan. 15, 2024, which are hereby incorporated by reference.

### TECHNICAL FIELD

This application relates generally to strollers and stroller seats for children.

### BACKGROUND

Strollers can save adults' physical energy in daily life, and they are also more comfortable for children to ride inside, which is deeply preferred by consumers. Consumers often have different demands for the height of seats in strollers. Some parents, for safety reasons, hope that the height of the seats is lower. Some parents hope to be closer to their children during travel, enhancing interaction between parents and children. In this case, consumers hope that the seat height can be higher. In addition, as children grow up, they will also have their own requirements for the height of the seats, such as wanting the seats to be higher for a wider view. Common strollers have seats that cannot be adjusted in height. Although a small number of strollers can adjust the seat height, there are often protruding rods above or below the seat or frame, which not only affect the normal folding of strollers, which also pose certain safety hazards and are not aesthetically pleasing.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

The technical problem to be solved by this invention is to overcome the defect that the lifting device of the stroller seat in the prior art comprises an exposed rod body, which not only affects the normal folding of the stroller, but also has certain safety hazards. A stroller scat lifting apparatus and a stroller using it are provided.

Aspects of the invention solve the above-mentioned technical problems through one or more of the following technical solutions including:

A stroller seat lifting apparatus for adjusting the height of a seat, wherein the stroller seat lifting apparatus comprises: a lifting platform, wherein the seat is disposed on the lifting platform, wherein the lifting platform is provided with an unlocking element, a resilient clement, and a positioning part, wherein the positioning part comprises a first and a second contact surfaces, wherein the positioning part can move between the first and second positions, wherein the resilient element is in contact with the first contact surface and applies a force towards the second position to the positioning part, and one end of the unlocking element is in contact with the second contact surface and can apply a force towards the first position to the positioning part; a base is disposed on the frame, and the base is provided with a chamber. The lifting platform can move up and down in the chamber, and the inner wall of the chamber is provided with a limiting part in the vertical direction. The number of limiting parts is 2 or more; when the positioning part is in the second position, it matches with the limiting part, and when the positioning part is in the first position, it separates from the limiting part.

In this embodiment, the above structural form is applied. When the unlocking element does not apply force to the second contact surface of the positioning part, the positioning part tends to move towards the second position under the action of the resilient element. At this point, if the lifting platform reaches the designed height, the positioning part and the limiting part are in the same horizontal plane. Under the action of the resilient element, the positioning part moves to the second position to match with the limiting part, and the lifting platform is locked in the vertical direction relative to the base. Because the seat is disposed on the lifting platform and the base is disposed on the frame, the seat is locked in the height direction relative to the frame. When the unlocking element applies a force to the second contact surface of the positioning part, the positioning part moves towards the first position and separates from the limiting part. The lifting platform can move freely in the vertical direction relative to the base. Due to the number of limiting parts being more than 2 and being disposed vertically on the inner wall of the chamber, the lifting platform can adjust the height by at least 2 gears, that is, the seat can adjust to at least 2 heights relative to the frame. Due to the presence of a chamber in the base, the lifting of the lifting platform is carried out inside the chamber. The entire stroller seat lifting apparatus has no exposed rod body, which will not affect the normal folding of the stroller and can avoid safety hazards.

In one or more embodiments, the stroller seat lifting apparatus further comprises a sleeve, and the seat can be detachably disposed on the lifting platform through the sleeve.

In this embodiment(s), the part of the lifting platform that extends out of the base during height adjustment can be wrapped by a sleeve and will not be exposed on the outside of the vehicle body. In addition, the sleeve can be detachable relative to the lifting platform, making it convenient for the assembly and separation of the seat and frame.

In one or more embodiments, the lifting platform is provided with a bayonet, which comprises a first and a second bayonet. The first and second bayonets are symmetrically arranged along the centerline of the lifting platform, and the sleeve is provided with a fitting portion, which can be detachably clamped with the first or second bayonets.

In this embodiment(s), as the first and second bayonets can be symmetrically arranged along the centerline of the lifting platform, the fitting part of the sleeve can be detachably clamped with the first or second bayonet. That is, the sleeve can be disposed on the lifting platform from the direction of the first bayonet or from the direction of the second bayonet, so the seat can be installed relative to the front and back of the frame.

In one or more embodiments, the sleeve is provided with a linkage element, which can apply a force towards the positioning part to the unlocking element. The linkage element can provide a simple control from the seat area to adjust the height of the seat, and the operation is simple.

In one or more embodiments, the lifting platform comprises a main body, wherein the main body is provided with a first sliding groove in the horizontal direction, and the positioning part is arranged within the first sliding groove and can extend out of the main body from the first sliding groove.

In this embodiment(s), the positioning part can move more smoothly between the first and second positions. When the positioning part is matched with the limiting part, the positioning part maintains the height of the lifting platform by applying an upward force to the first sliding groove. This structure is simple and reliable, with low manufacturing costs.

In one or more embodiments, the outer wall of the main body is in contact with the inner wall of the chamber.

In this embodiment(s), as there is no gap between the outer wall of the main body and the inner wall of the chamber, the lifting platform will not experience horizontal shaking during the up and down movement, making the lifting process more stable.

In one or more embodiments, the main body is provided with a second sliding groove in the vertical direction, which is connected to the first sliding groove. The unlocking member is disposed inside the second sliding groove, and the other end of the unlocking member extends out of the upper surface of the base.

In this embodiment(s), the unlocking element can move up and down within the second sliding groove and apply a force to the positioning part through the connection between the second sliding groove and the first sliding groove. In addition, the other end of the unlocking element extends out of the upper surface of the base, making it convenient for users to control the unlocking element.

In one or more embodiments, the first sliding groove runs through the main body, and the second sliding groove is connected to the middle position of the first sliding groove. In one or more embodiments, the number of positioning parts is 2, and the 2 positioning parts are respectively disposed on both sides of the first sliding groove.

In this embodiment(s), two positioning parts are disposed at both ends of the first sliding groove, and the second sliding groove is connected to the middle position of the first sliding groove. The unlocking element can control the two positioning parts to push out towards both sides of the main body by moving, that is, to move towards the second position. At this point, both sides of the main body can be locked with the limiting part, making the lifting platform more stable and reliable.

In one or more embodiments, the positioning part comprises a first end and a second end, wherein the first end is provided on the side away from the limiting part of the unlocking element, the second end is provided on the side close to the limiting part of the unlocking element, the second contact surface is an inclined plane and is disposed on the first end, and the end face of the unlocking element and the second contact surface are inclined planes, and the second end is matched with the limiting part.

In this embodiment(s), the first end is disposed on the side away from the limiting part of the unlocking element, and the end face of the unlocking element and the second contact surface are mutually matched inclined planes. When the unlocking element moves downwards, the force applied by the end face of the unlocking element to the second contact surface comprises a component force towards the direction away from the limiting part. When the first end moves away from the limiting part, it drives the second end to separate from the limiting part.

In one or more embodiments, the second end is provided with an accommodating groove, and the first sliding groove is fixedly provided with a fixing part, which is located inside the accommodating groove. When the positioning part moves between the first and second positions, the accommodating groove can move relative to the fixing part. One end of the resilient element is fixedly disposed on the fixing part, and the other end of the resilient element is abutted on the inner wall of the accommodating groove near the limiting part and applies a force towards the direction of the limiting part to the second end.

In this embodiment(s), the fixing part is fixed in the first sliding groove. When the second end moves away from the limiting part, the resilient element between the fixing part and the accommodating groove is compressed, and a force towards the direction of the limiting part is applied to the accommodating groove at the second end.

In one or more embodiments, the positioning part comprises a connecting piece, and the first end and the second end are connected through the connecting piece.

In this embodiment(s), the above-mentioned structural form is applied, with a thinner thickness of the connecting piece and a larger space for the positioning part between the first and second ends, making it convenient for the unlocking element to move up and down.

A stroller, wherein the stroller comprises a stroller seat lifting apparatus according to one or more embodiments described above.

In this embodiment(s), when the unlocking element does not apply a force to the second contact surface of the positioning part, the positioning part tends to move towards the second position under the action of the resilient clement. At this point, if the lifting platform reaches the designed height, the positioning part and the limiting part are in the same horizontal plane. Under the action of the resilient element, the positioning part moves to the second position to cooperate with the limiting part, and the lifting platform is locked in the vertical direction relative to the base. When the unlocking element applies a force to the second contact surface of the positioning part, the positioning part moves towards the first position and separates from the limiting part. The lifting platform can move freely in the vertical direction relative to the base. Due to the number of limiting parts being more than 2 and being disposed vertically on the inner wall of the chamber, the lifting platform can adjust the height by at least 2 gears. Due to the presence of a chamber in the base, the lifting of the lifting platform is carried out inside the chamber. The entire stroller seat lifting apparatus has no exposed rod body, which will not affect the normal folding of the stroller and can avoid safety hazards.

The positive progressive effect of this invention, according to one or more embodiments, is that when the unlocking element does not apply a force to the second contact surface of the positioning part, the positioning part tends to move towards the second position under the action of the resilient element. At this point, if the lifting platform reaches the design height, the positioning part and the limiting part are in the same horizontal plane. Under the action of the resilient element, the positioning part moves to the second position to cooperate with the limiting part, and the lifting platform is locked in the vertical direction relative to the base. Because the seat is disposed on the lifting platform and the base is disposed on the frame, the seat is locked in the height direction relative to the frame. When the unlocking element applies a force to the second contact surface of the positioning part, the positioning part moves towards the first position and separates from the limiting part. The lifting platform can move freely in the vertical direction relative to the base. Due to the number of limiting parts being more than 2 and being disposed vertically on the inner wall of the chamber, the lifting platform can adjust the height by at least 2 gears, that is, the seat can adjust the height by at least 2 gears relative to the frame. Due to the presence of a chamber in the base, the lifting of the lifting platform is carried out inside the chamber. The entire stroller seat lifting apparatus has no exposed rod body, which will not affect the normal folding of the stroller and can avoid safety hazards.

Another aspect of the invention is directed to a height-adjustable seat apparatus comprising a frame; a seat; a base attached to the frame, the base including an inner wall that defines, at least in part, a chamber that extends along a first axis, the inner wall defining a plurality of height slots that are spaced along the first axis, each height slot extending parallel to a second axis that is orthogonal to the first axis; a lifting platform attached to the seat, the lifting platform disposed in the chamber and configured to slidably engage the base within the chamber so as to position the seat vertically relative to the base; a positioning body slidably disposed on the lifting platform, the positioning body having first and second ends, the second end closer to the inner wall of the base than the first end; a spring configured to apply a bias force on the positioning body to slide the positioning body in a first direction, parallel to the second axis, from an unlocked position to a locked position; and an unlocking platform having (a) an engaged state in which the locking platform mechanically engages the first end of the positioning body to slide the positioning body in a second direction, parallel to the second axis, from the locked position to the unlocked position and (b) a disengaged state in which the locking platform is mechanically disengaged from the first end of the positioning body. When the positioning slot is aligned in a same horizontal plane as one of the height slots and the positioning body is in the locked position, the second end of the positioning body is disposed in the one of the height slots to transition the lifting platform into a locked state in which the position of the lifting platform with respect to the base is locked to thereby set a height of the seat, the height corresponding to a vertical position of the one of the height slots along the inner wall of the base. When the positioning body is in the unlocked position, the second end of the positioning body is not disposed in any of the height slots to transition the lifting platform into an unlocked state in which the lifting platform can slide within the chamber so as to position the seat vertically relative to the base.

In one or more embodiments, the apparatus further comprises a sleeve releasably attached to a first end of the lifting platform, the first end of the lifting platform disposed closer to the seat than a second end of the lifting platform. In one or more embodiments, the first end of the lifting platform includes first and second latches, each of the first and second latches configured to detachably clamp a complementary portion of the sleeve. In one or more embodiments, the first and second latches are symmetrically disposed about a centerline of the lifting platform, the centerline parallel to the first axis. In one or more embodiments, the sleeve includes a linkage body configured to transmit a linkage body force to the unlocking platform.

In one or more embodiments, the lifting platform includes a main body that defines a first sliding groove that extends parallel to the second axis, the positioning body disposed within the first sliding groove. In one or more embodiments, the main body includes an outer wall that is in direct physical contact with the inner wall of the base. In one or more embodiments, a second sliding groove is defined in the main body, the second sliding groove extending parallel to the first axis, the unlocking platform disposed within the second sliding groove to vertically position the unlocking platform, the second sliding groove extending to the first sliding groove.

In one or more embodiments, the lifting platform including first and second ends, the first end of the lifting platform disposed closer to the seat than the second end of the lifting platform, the first end of the lifting platform disposed away from an upper surface of the base, the second end of the lifting platform disposed within the second sliding groove. In one or more embodiments, the positioning body is a first positioning body, the inner wall is a first inner wall, the height slots are first height slots, and the apparatus further comprises a second positioning body disposed within the first sliding groove, the first and second positioning bodies on opposing sides of the first sliding groove, wherein the base includes a second inner wall that defines, at least in part, the chamber, the second inner wall defining a plurality of second height slots that are spaced along the first axis, each second height slot extending parallel to the second axis and aligned with a respective first height slot.

In one or more embodiments, each of the first and second positioning bodies includes a respective first end and a respective second end, the respective first end disposed further away from a respective inner wall than the respective second end; the respective first end includes a first inclined contact surface, an end face of the unlocking platform includes a pair of second inclined surfaces that are configured to mechanically contact the first inclined contact surface on the respective first end of the first and second positioning bodies, and the respective second end has a complementary shape to respective height slots. In one or more embodiments, the spring is a first spring configured to apply a first bias force, the unlocked position is a first unlocked position, the locked position is a first locked position, the apparatus further comprises a second spring configured to apply a second bias force on the second positioning body to slide the second positioning body in the second direction from a second unlocked position to a second locked position, wherein a respective accommodating groove is defined in the respective second end of the first and second positioning bodies, a respective pin is attached to the positioning slot within the respective accommodating groove, a respective first end of a respective spring is attached to the respective pin, a respective second end of the respective spring is attached to a respective inner wall of the respective accommodating groove, and each accommodating groove is configured to move, parallel to the second axis, with a respective positioning body relative to the respective pin.

In one or more embodiments, the respective first and second ends of each of the first and second positioning bodies are connected by a respective connecting piece.

In one or more embodiments, the first end of the positioning body includes a first inclined contact surface, an end face of the unlocking platform includes a second inclined surface that is configured to mechanically contact the first inclined contact surface when the unlocking platform is in the engaged state, and the second end of the positioning body has a complementary shape to the height slots.

Another aspect of the invention is directed to the apparatus as described herein; and a plurality of wheels attached to the frame.

Another aspect of the invention is directed to the first and second apparatuses, each apparatus as described herein; and a plurality of wheels attached to the frame.

Another aspect of the invention is directed to a height-adjustable seat apparatus comprising a frame; a seat; a base attached to the frame, the base including first and second inner wall that define, at least in part, a chamber that extends along a first axis, each inner wall defining a plurality of height slots that are spaced along the first axis, each height slot extending parallel to a second axis that is orthogonal to the first axis, each height slot of the first inner wall vertically aligned with a respective height slot of the second inner wall; a lifting platform attached to the seat, the lifting platform disposed in the chamber and configured to slidably engage the base within the chamber so as to position the seat vertically relative to the base; first and second positioning bodies slidably disposed on opposing sides of the lifting platform, each positioning body having respective first and second ends, the respective second end closer to a respective inner wall of the base than the first end; first and second springs configured to apply a respective bias force on the first and second positioning bodies, respectively, to slide each positioning body outwardly, in a first direction parallel to the second axis, from a respective unlocked position to a respective locked position; and an unlocking platform having (a) an engaged state in which the locking platform mechanically engages the respective first end of each positioning body to slide each positioning body inwardly, in a second direction parallel to the second axis, from the respective locked position to the respective unlocked position and (b) a disengaged state in which the locking platform is mechanically disengaged from the respective first end of each positioning body. When the positioning slot is aligned in a same horizontal plane as one of the height slots on each inner wall and each positioning body is in the respective locked position, the respective second end of each positioning body is disposed in the one of the height slots on each inner wall to transition the lifting platform into a locked state in which the position of the lifting platform with respect to the base is locked to thereby set a height of the seat, the height corresponding to a vertical position of the one of the height slots along each inner wall of the base. When each positioning body is in the respective unlocked position, the respective second end of each positioning body is not disposed in any of the height slots on each inner wall to transition the lifting platform into an unlocked state in which the lifting platform can slide within the chamber so as to position the seat vertically relative to the base.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a schematic diagram a seat and a sleeve according to one or more embodiments.

FIG. 2 is a schematic diagram of a frame according to one or more embodiments.

FIG. 3 is a schematic diagram of a lifting platform and a base according to one or more embodiments.

FIG. 4 is an exploded view of a lifting platform according to one or more embodiments.

FIG. 5 is an exploded view of a sleeve according to one or more embodiments.

FIG. 6 is a schematic diagram of a clamping part and a fitting part according to one or more embodiments.

FIG. 7 is a schematic diagram of a sleeve and a base according to one or more embodiments.

FIG. 8 is schematic diagram of a seat lifting assembly according to one or more embodiments.

FIG. 9 is a schematic diagram of an unlocking element and a positioning part according to one or more embodiments.

FIG. 10 is an isolated schematic diagram of the unlocking element and one of the positioning parts shown in FIG. 10 according to one or more embodiments.

FIG. 11 is an isolated schematic diagram of a positioning part according to one or more embodiments.

### DETAILED DESCRIPTION

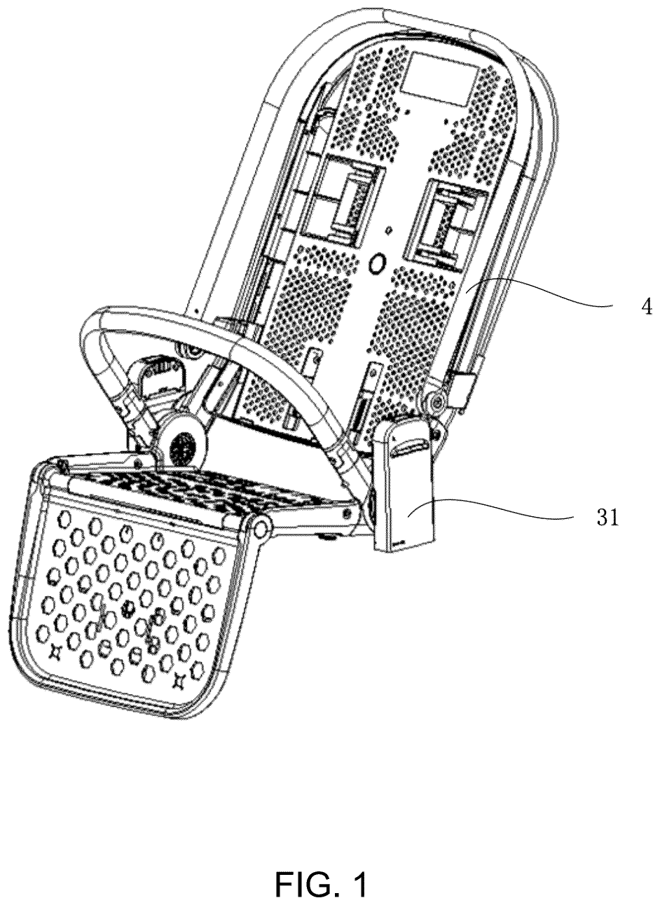

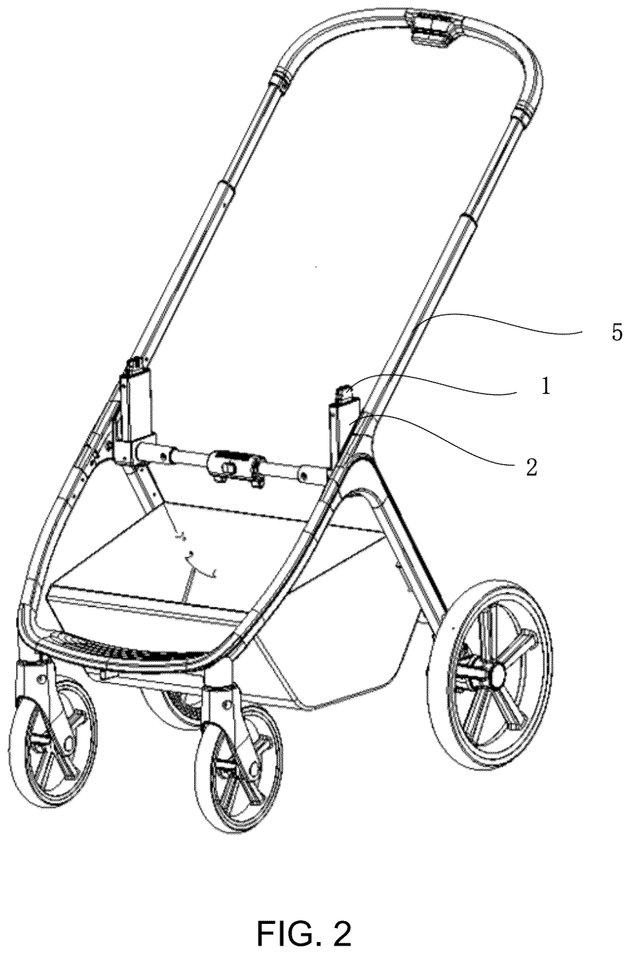

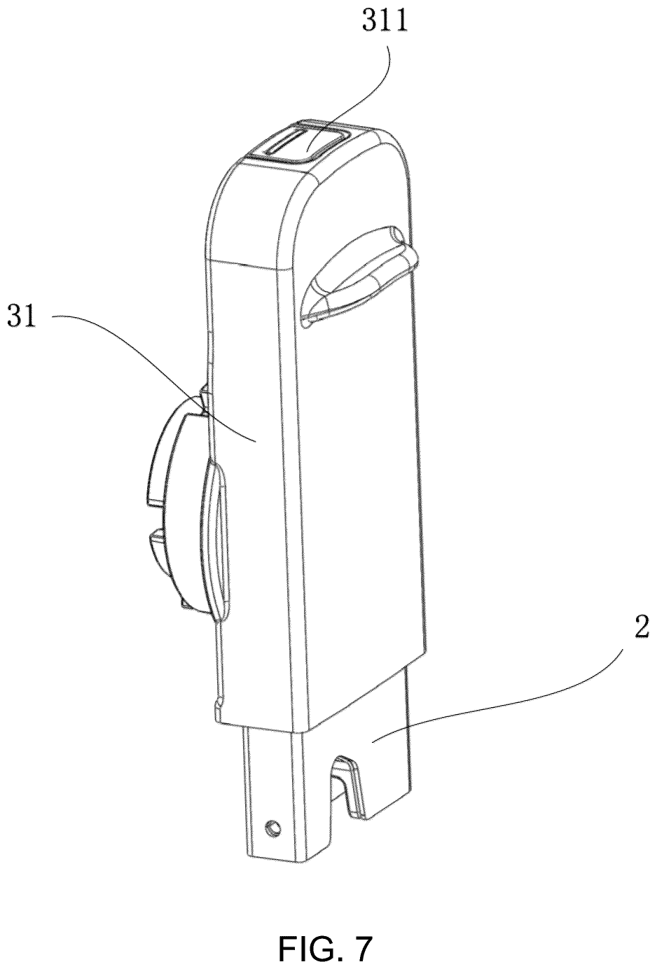

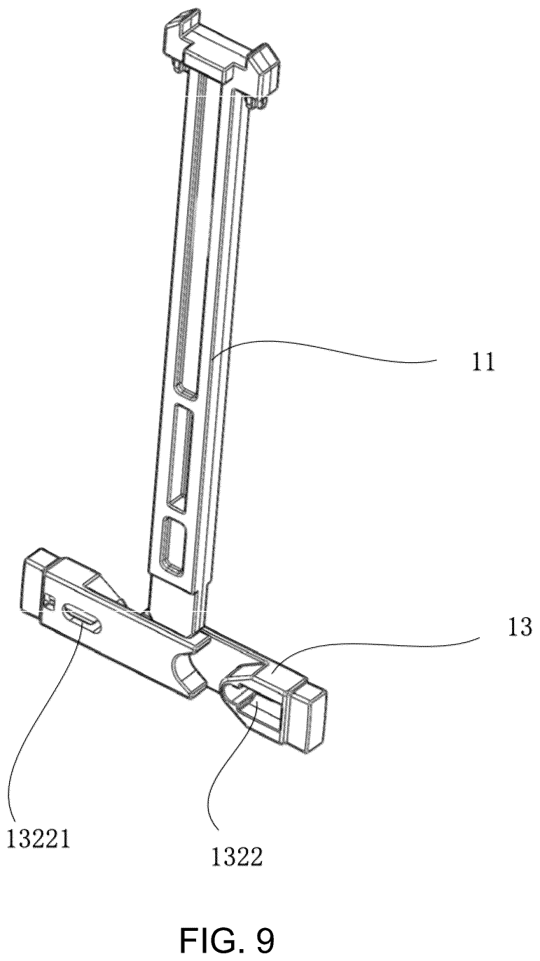

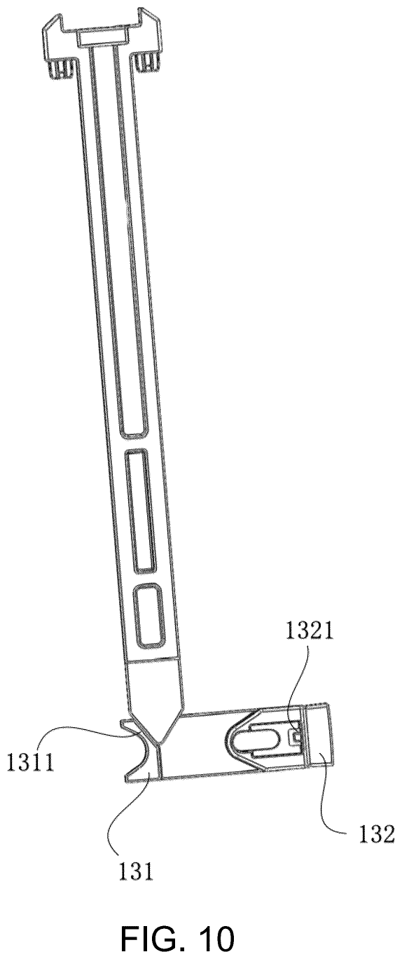

As shown in FIGS. 1 to 11, aspects of the invention provide a stroller seat lifting apparatus for adjusting the height of seat 4. The stroller seat lifting apparatus comprises a lifting platform 1 and a seat 4 is disposed on the lifting platform 1. The lifting platform 1 is provided with an unlocking element 11, a resilient element 12, and a positioning part 13. The positioning part 13 comprises a first contact surface 1321 and a second contact surface 1311, and the positioning part 13 can move freely between first and second positions, for example parallel to a second axis that is parallel to a horizontal plane. The first and second positions can alternately be referred to as unlocked and locked positions, respectively. The resilient element 12 is in contact with the first contact surface 1321 and applies a force towards the positioning part 13 towards the second position. One end of the unlocking element 11 is in contact with the second contact surface 1311 and can be applied to the positioning part 13 to force the positioning part towards the first position.

A base 2 is installed on the frame 5, and base 2 is provided with a chamber 21. The lifting platform 1 can move up and down inside the chamber 21. An inner wall of the chamber 21 is provided with limiting parts 211 spaced in a vertical direction (e.g,. along or parallel to a first axis), which can be in a slot-like shape. The limiting parts 211 can alternatively be referred to as height slots. Each height slot extends parallel to a second axis that is orthogonal to the first axis and that is parallel to a horizontal plane. The number of limiting parts 211 can be 3 or another number in one or more embodiments. When the positioning part 13 is in the second position, it cooperates with the limiting part 211, and when the positioning part 13 is in the first position, it separates from the limiting part 211.

When the unlocking element 11 does not apply a force to the second contact surface 1311 of the positioning part 13, the positioning part 13 tends to move towards the second position under the action of the resilient element 12. At this point, if the lifting platform 1 reaches a design height, the positioning part 13 and the limiting part 211 are in the same horizontal plane. Under the action of the resilient element 12, the positioning part 13 moves to the second position to cooperate with the limiting part 211, and the lifting platform 1 is locked vertically relative to the base 2. Because seat 4 is disposed on lifting platform 1 and base 2 is disposed on frame 5, seat 4 is locked in the height direction relative to frame 5. When unlocking clement 11 applies a force to the second contact surface 1311 of the positioning part 13, the positioning part 13 moves towards the first position and separates from the limiting part 211. When the positioning part 13 is moved towards the first position and away from the limiting part 211, the lifting platform I can move freely in the vertical direction relative to the base 2. Due to the number of limiting parts 211 being three (or another number) and being disposed vertically on the inner wall of chamber 21, the lifting platform I can adjust the height to one of 3 vertical positions, relative to the frame 5, corresponding to the locations of the limiting parts 211. Due to the presence of chamber 21 in base 2, the lifting of lifting platform 1 is carried out inside chamber 21. The entire stroller seat lifting apparatus has no exposed rod body, which will not affect the normal folding of the stroller and can avoid safety hazards.

As shown in FIGS. 1, 2, and 7, in one or more embodiments, the stroller seat lifting apparatus further comprises a sleeve 31, and the seat 4 can be detachably disposed on the lifting platform 1 through the sleeve 31.

In this embodiment(s), the portion of the lifting platform 1 that extends out of the base during height adjustment is wrapped by the sleeve 31 and will not be exposed on the outside of the lifting apparatus. In addition, the sleeve 31 is detachable relative to the lifting platform 1, which facilitates the assembly and separation of seat 4 and frame 5.

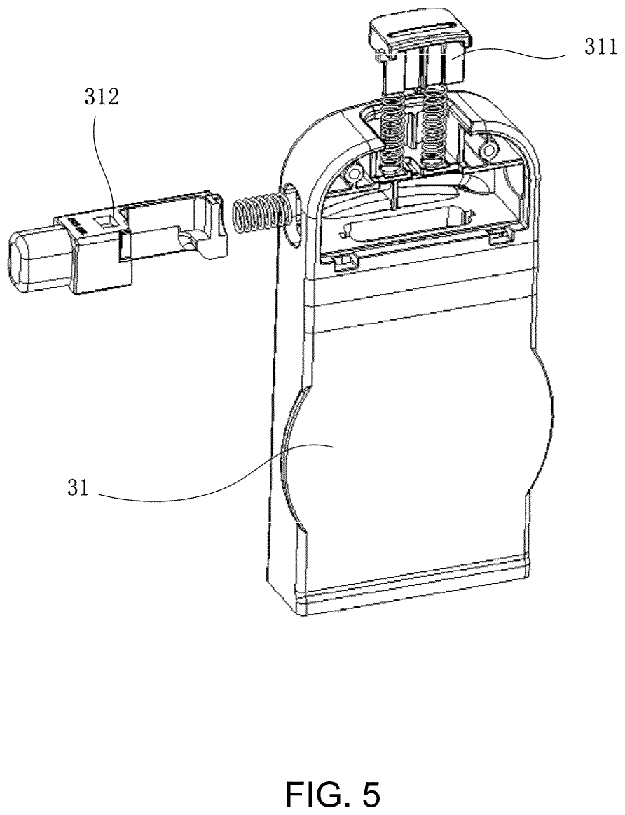

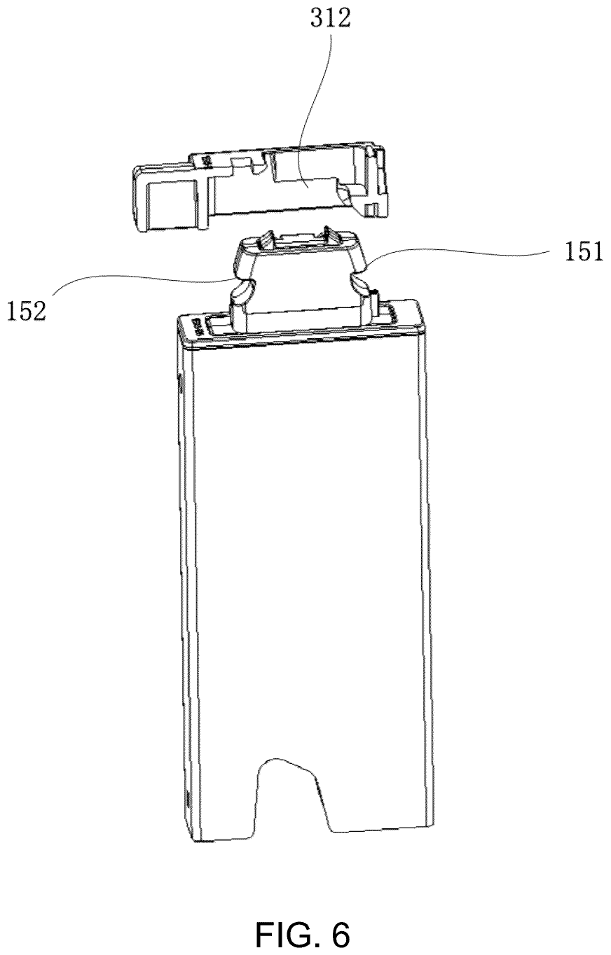

As shown in FIGS. 5-6, in one or more embodiments, the lifting platform 1 is provided with a bayonet 15, which comprises a first bayonet 151 and a second bayonet 152. The first bayonet 151 and the second bayonet 152 are symmetrically arranged along the centerline of the lifting platform 1. The sleeve 31 is provided with a fitting part 312, which can be detachably clamped with the first bayonet 151 or the second bayonet 152. The first and second bayonets 151, 152 can alternately be referred to as first and second latches, respectively.

In this embodiment(s), due to the symmetrical arrangement of the first bayonet 151 and the second bayonet 152 along the centerline of the lifting platform 1, the fitting part 312 of the sleeve 31 can be detachably clamped with the first bayonet 151 or the second bayonet 152. That is, the sleeve 31 can be installed on the lifting platform from the direction of the first bayonet 151 or from the direction of the second bayonet 152, so that the seat 4 can be installed in front and back relative to the frame 5.

In one or more embodiments, the sleeve 31 is provided with a linkage element 311, which can apply a force towards the positioning part 13 to the unlocking element 11. The linkage element 311 can provide a simple control to adjust the height setting of the seat 4, and the operation is simple.

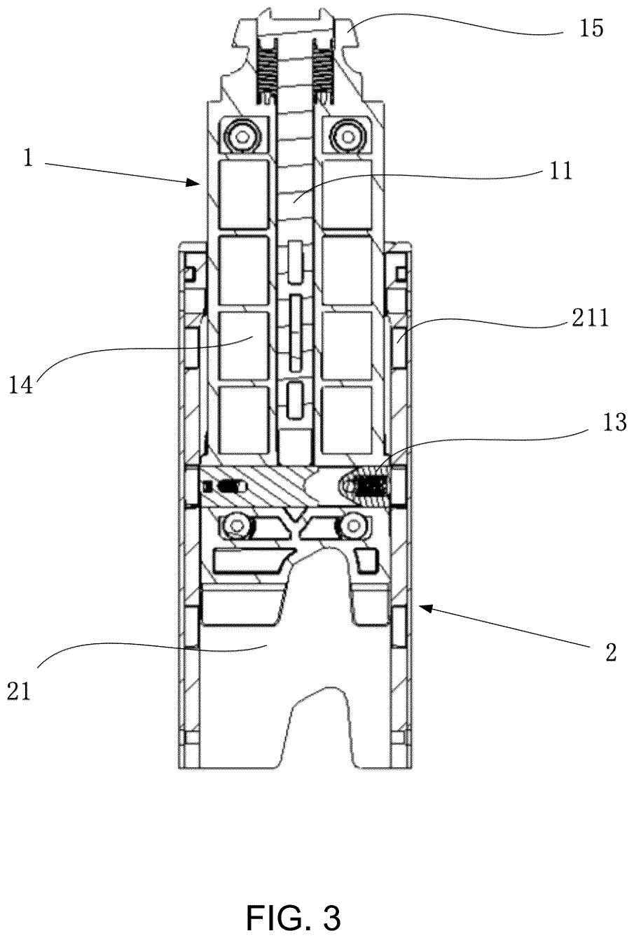

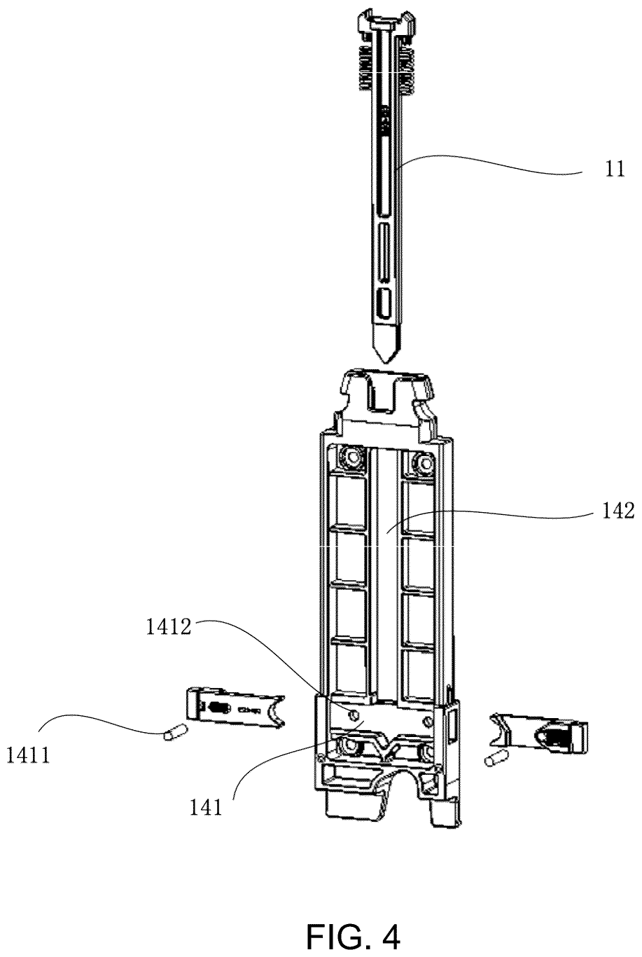

As shown in FIGS. 3 and 4, in one or more embodiments, the lifting platform 1 comprises a main body 14, which is provided with reinforcing ribs. The main body 14 is provided with a first sliding groove 141 in the horizontal direction, and the positioning part 13 is movable within the first sliding groove 141 and can extend out of the main body 14 from the first sliding groove 141.

In this embodiment(s), the positioning part 13 moves more smoothly between the first and second positions. When the positioning part 13 is matched with the limiting part 211, the positioning part 13 maintains the height of the lifting platform 1 by applying an upward force to the first sliding groove 141. This structure is simple and reliable, with low manufacturing costs.

In one or more embodiments, the outer wall of the main body 14 is in contact with the inner wall of the chamber 21.

In this embodiment(s), as there is no gap between the outer wall of the main body 14 and the inner wall of the chamber 21, the lifting platform 1 will not experience horizontal shaking during the up and down movement, making the lifting process more stable.

In one or more embodiments, the main body 14 is provided with a second sliding groove 142 in the vertical direction, which is connected to the first sliding groove 141. The unlocking element 11 is arranged inside the second sliding groove 142, and the other end of the unlocking element 11 extends out of the upper surface of the base 2.

In this embodiment(s), the unlocking element 11 can move up and down within the second sliding groove 142, and apply a force to the positioning part 13 through the connection between the second sliding groove 142 and the first sliding groove 141. In addition, the other end of the unlocking element 11 extends out of the upper surface of the base 2, making it convenient for the user to control the unlocking element 11.

In one or more embodiments, the first sliding groove 141 runs through the main body 14, and the second sliding groove 142 is connected to the middle position of the first sliding groove 141. The number of positioning parts 13 can be 2, and the two positioning parts 13 are respectively disposed on both sides of the first sliding groove 141.

In this embodiment(s), two positioning parts 13 are respectively disposed at both ends of the first sliding groove 141, and the second sliding groove 142 is connected to the middle position of the first sliding groove 141. The unlocking clement 11 can control the two positioning parts 13 to push out towards both sides of the main body 14 by moving, that is, to move towards the second position. At this time, both sides of the main body 14 can be locked with the limiting part 211, making the lifting platform 1 in a more stable and reliable state.

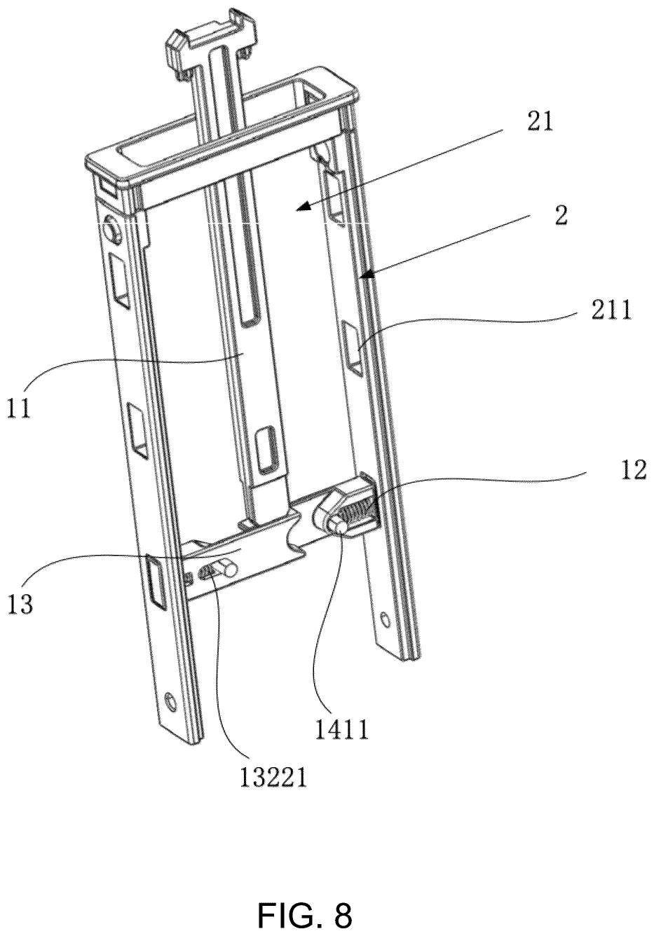

In one or more embodiments, as shown in FIGS. 8 to 11, the positioning portion 13 comprises a first end 131 and a second end 132. The first end 131 is provided on the side away from the limiting part 211 of the unlocking element 11, the second end 132 is provided on the side near the limiting part 211 of the unlocking element 11, and the second contact surface 1311 is an inclined surface and is disposed on the first end 131. The end face of the unlocking element 11 that is in contact with the second contact surface 1311 is an inclined surface, and the second end 132 is matched with the limiting part 211.

In this embodiment(s), as the first end 131 is disposed on the side away from the limiting part 211 of the unlocking element 11, the end face of the unlocking element 11 and the second contact surface 1311 are mutually matched inclined planes. When the unlocking element 11 moves downwards, the force applied by the end face of the unlocking element 11 to the second contact surface 1311 comprises a component force towards the direction away from the limiting part 211. When the first end 131 moves away from the limiting part 211, it drives the second end 132 to separate from the limiting part 211.

In one or more embodiments, as shown in FIGS. 4, 8, and 11, the second end 132 is provided with an accommodating groove 1322, and the first sliding groove 141 is fixedly provided with a fixing part 1411, which can be a pin. The first sliding groove 141 can be provided with a pin hole 1412, and the fixing part 1411 can be fixedly placed inside the first sliding groove 141 through the pin hole 1412. The bottom of the groove that accommodates the groove 1322 is also provided with a long strip gap 13221. The size of the gap 13221 is determined based on the distance between the locking and unlocking stroke of the positioning part 13 and the limiting part 211. For example, if the width of the gap 13221 is selected to be greater than the diameter of the fixing part 1411 and/or the pin hole 1412, when the positioning part 13 moves between the first and second positions, it can move back and forth relative to the fixing part 1411 in the travel gap of the elongated gap 13221. Therefore, the positioning part 13 can achieve reciprocating movement in the first and second positions to lock or release the lifting platform 1.

The resilient element 12 can be a spring, which utilizes a bias force of the resilient element 12 to promote a bias movement of the positioning part 13 towards the position of the limiting part 211. If one end of the resilient element 12 is fixed on the fixing part 1411, the other end of the resilient element 12 is abutted against the inner wall of the accommodating groove 1322 near the limiting part 211, and the bias force in the direction of the limiting part 211 is applied to the second end 132. There is also a spring installed on the unlocking element 11. When the unlocking clement 11 moves downwards, the spring is compressed and applies an upward force to the unlocking element 11, making the rebound or redisposed effect of the positioning part 13 better. Of course, in other embodiments, there is no need to dispose springs on the unlocking element 11.

In this embodiment(s), the fixing part 1411 is fixedly arranged in the first sliding groove 141. When the second end 132 moves away from the limiting part 211, the resilient element 12 between the fixing part 1411 and the accommodating groove 1322 is compressed, and a force towards the limiting part 211 is applied to the accommodating groove 1322 of the second end 132. Of course, in other embodiments, the accommodating groove 1322 can also run through the second end 132, meaning that the accommodating groove 1322 has no groove bottom, and in this embodiment(s), the accommodating groove 1322 can also move relative to the pin 1411. In addition, if the accommodating groove 1322 has a groove bottom, and the fixing part 1411 is a convex block facing the opening side of the first sliding groove 141 towards the accommodating groove 1322, that is, the fixing part 1411 does not penetrate the positioning part 13, corresponding functions can also be achieved in another embodiment(s).

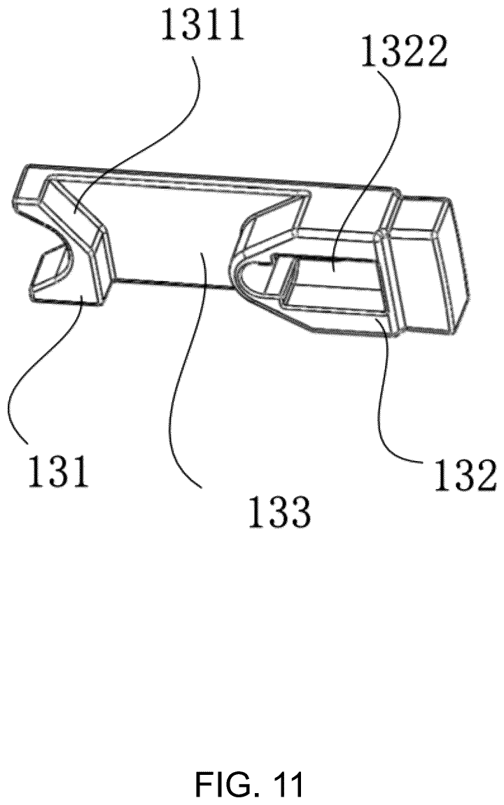

In one or more embodiments, as shown in FIG. 11, the positioning part 13 comprises a connecting piece 133, with the first end 131 and the second end 132 connected through the connecting piece 133.

In this embodiment(s), the connecting piece 133 has a thin thickness. The positioning part 13 has a large space between the first end 131 and the second end 132, which facilitates the up and down movement of the unlocking element 11.

In one or more embodiments a stroller is provided, which comprises the above- mentioned stroller seat lifting apparatus. The stroller can include multiple wheels attached a bottom of the frame.

In this embodiment(s), when the unlocking element 11 does not apply a force to the second contact surface 1311 of the positioning part 13, the positioning part 13 tends to move towards the second position under the action of the resilient element 12. At this point, if the lifting platform I reaches the design height, the positioning part 13 and the limiting part 211 are in the same horizontal plane. Under the action of the resilient element 12, the positioning part 13 moves to the second position to cooperate with the limiting part 211, and the lifting platform 1 is locked vertically relative to the base 2. When unlocking element 11 applies a force to the second contact surface 1311 of the positioning part 13, the positioning part 13 moves towards the first position and separates from the limiting part 211. When the positioning part 13 moves towards the first position and separates from the limiting part 211, the lifting platform 1 can move freely in the vertical direction relative to the base 2. Due to the number of limiting parts 211 being more than 2 and being disposed vertically on the inner wall of chamber 21, lifting platform 1 can adjust to at least 2 heights. Due to the presence of chamber 21 in base 2, the lifting of lifting platform 1 is carried out inside chamber 21. The entire stroller seat lifting apparatus has no exposed rod body, which will not affect the normal folding of the stroller and can avoid safety hazards.

Although the specific embodiments of this invention are described above, those skilled in the art should understand that this is only an example, and the scope of protection of this invention is limited by the accompanying claims. Technicians in this field may make various changes or modifications to these embodiments without departing from the principles and essence of this invention, but these changes and modifications fall within the scope of protection of this invention.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A height-adjustable seat apparatus comprising:
a frame;
a seat;
a base attached to the frame, the base including an inner wall that defines, at least in part, a chamber that extends along a first axis, the inner wall defining a plurality of height slots that are spaced along the first axis, each height slot extending parallel to a second axis that is orthogonal to the first axis;
a lifting platform attached to the seat, the lifting platform disposed in the chamber and configured to slidably engage the base within the chamber so as to position the seat vertically relative to the base;
a positioning body slidably disposed on the lifting platform, the positioning body having first and second ends, the second end closer to the inner wall of the base than the first end;
a spring configured to apply a bias force on the positioning body to slide the positioning body in a first direction, parallel to the second axis, from an unlocked position to a locked position; and
an unlocking platform having (a) an engaged state in which the locking platform mechanically engages the first end of the positioning body to slide the positioning body in a second direction, parallel to the second axis, from the locked position to the unlocked position and (b) a disengaged state in which the locking platform is mechanically disengaged from the first end of the positioning body,
wherein:
when the positioning slot is aligned in a same horizontal plane as one of the height slots and the positioning body is in the locked position, the second end of the positioning body is disposed in the one of the height slots to transition the lifting platform into a locked state in which the position of the lifting platform with respect to the base is locked to thereby set a height of the seat, the height corresponding to a vertical position of the one of the height slots along the inner wall of the base, and
when the positioning body is in the unlocked position, the second end of the positioning body is not disposed in any of the height slots to transition the lifting platform into an unlocked state in which the lifting platform can slide within the chamber so as to position the seat vertically relative to the base.

2. The apparatus of claim 1, further comprising a sleeve releasably attached to a first end of the lifting platform, the first end of the lifting platform disposed closer to the seat than a second end of the lifting platform.

3. The apparatus of claim 2, wherein the first end of the lifting platform includes first and second latches, each of the first and second latches configured to detachably clamp a complementary portion of the sleeve.

4. The apparatus of claim 3, wherein the first and second latches are symmetrically disposed about a centerline of the lifting platform, the centerline parallel to the first axis.

5. The apparatus of claim 2, wherein the sleeve includes a linkage body configured to transmit a linkage body force to the unlocking platform.

6. The apparatus of claim 1, wherein the lifting platform includes a main body that defines a first sliding groove that extends parallel to the second axis, the positioning body disposed within the first sliding groove.

7. The apparatus of claim 6, wherein the main body includes an outer wall that is in direct physical contact with the inner wall of the base.

8. The apparatus of claim 6, wherein a second sliding groove is defined in the main body, the second sliding groove extending parallel to the first axis, the unlocking platform disposed within the second sliding groove to vertically position the unlocking platform, the second sliding groove extending to the first sliding groove.

9. The apparatus of claim 8, wherein the lifting platform including first and second ends, the first end of the lifting platform disposed closer to the seat than the second end of the lifting platform, the first end of the lifting platform disposed away from an upper surface of the base, the second end of the lifting platform disposed within the second sliding groove.

10. The apparatus of claim 8, wherein:
the positioning body is a first positioning body,
the inner wall is a first inner wall,
the height slots are first height slots, and
the apparatus further comprises a second positioning body disposed within the first sliding groove, the first and second positioning bodies on opposing sides of the first sliding groove,
wherein the base includes a second inner wall that defines, at least in part, the chamber, the second inner wall defining a plurality of second height slots that are spaced along the first axis, each second height slot extending parallel to the second axis and aligned with a respective first height slot.

11. The apparatus of claim 10, wherein:
each of the first and second positioning bodies includes a respective first end and a respective second end, the respective first end disposed further away from a respective inner wall than the respective second end;
the respective first end includes a first inclined contact surface,
an end face of the unlocking platform includes a pair of second inclined surfaces that are configured to mechanically contact the first inclined contact surface on the respective first end of the first and second positioning bodies, and
the respective second end has a complementary shape to respective height slots.

12. The apparatus of claim 11, wherein:
the spring is a first spring configured to apply a first bias force,
the unlocked position is a first unlocked position,
the locked position is a first locked position,
the apparatus further comprises a second spring configured to apply a second bias force on the second positioning body to slide the second positioning body in the second direction from a second unlocked position to a second locked position,
wherein:
a respective accommodating groove is defined in the respective second end of the first and second positioning bodies,
a respective pin is attached to the positioning slot within the respective accommodating groove,
a respective first end of a respective spring is attached to the respective pin,
a respective second end of the respective spring is attached to a respective inner wall of the respective accommodating groove, and
each accommodating groove is configured to move, parallel to the second axis, with a respective positioning body relative to the respective pin.

13. The apparatus of claim 11, wherein the respective first and second ends of each of the first and second positioning bodies are connected by a respective connecting piece.

14. The apparatus of claim 1, wherein:
the first end of the positioning body includes a first inclined contact surface,
an end face of the unlocking platform includes a second inclined surface that is configured to mechanically contact the first inclined contact surface when the unlocking platform is in the engaged state, and
the second end of the positioning body has a complementary shape to the height slots.

15. A stroller comprising:
the apparatus of claim 1; and
a plurality of wheels attached to the frame.

16. A stroller comprising:
first and second apparatuses, each apparatus according to claim 1; and
a plurality of wheels attached to the frame.

17. A height-adjustable seat apparatus comprising:
a frame;
a seat;
a base attached to the frame, the base including first and second inner wall that define, at least in part, a chamber that extends along a first axis, each inner wall defining a plurality of height slots that are spaced along the first axis, each height slot extending parallel to a second axis that is orthogonal to the first axis, each height slot of the first inner wall vertically aligned with a respective height slot of the second inner wall;
a lifting platform attached to the seat, the lifting platform disposed in the chamber and configured to slidably engage the base within the chamber so as to position the seat vertically relative to the base;
first and second positioning bodies slidably disposed on opposing sides of the lifting platform, each positioning body having respective first and second ends, the respective second end closer to a respective inner wall of the base than the first end;
first and second springs configured to apply a respective bias force on the first and second positioning bodies, respectively, to slide each positioning body outwardly, in a first direction parallel to the second axis, from a respective unlocked position to a respective locked position; and
an unlocking platform having (a) an engaged state in which the locking platform mechanically engages the respective first end of each positioning body to slide each positioning body inwardly, in a second direction parallel to the second axis, from the respective locked position to the respective unlocked position and (b) a disengaged state in which the locking platform is mechanically disengaged from the respective first end of each positioning body,
wherein:
when the positioning slot is aligned in a same horizontal plane as one of the height slots on each inner wall and each positioning body is in the respective locked position, the respective second end of each positioning body is disposed in the one of the height slots on each inner wall to transition the lifting platform into a locked state in which the position of the lifting platform with respect to the base is locked to thereby set a height of the seat, the height corresponding to a vertical position of the one of the height slots along each inner wall of the base, and
when each positioning body is in the respective unlocked position, the respective second end of each positioning body is not disposed in any of the height slots on each inner wall to transition the lifting platform into an unlocked state in which the lifting platform can slide within the chamber so as to position the seat vertically relative to the base.
